(19) United States
(12) Patent Application Publication
(10) Pub. No.: US 2012/0043488 A1
(43) Pub. Date: Feb. 23, 2012

(54) MOTORIZED VALVE

(76) Inventor: Craig NIMMO, Buderim (AU)

(21) Appl. No.: 13/212,810

(22) Filed: Aug. 18, 2011

(30) Foreign Application Priority Data
Aug. 20, 2010 (AU) 2010903741

(51) Int. Cl. F16K 5/00

(52) U.S. Cl. 251/304

(57) ABSTRACT

A motorized valve including: a valve body having a housing wall and one or more inlet ports and a plurality of outlet ports penetrating the housing wall; each outlet port being arranged in spaced relationship from one another about a seat face, said seat face substantially conforming to an inner face of circular cylinder and each said outlet port having an orifice penetrating said seat face; a valve stopper having a stopper body formed with a sealing face conforming to an outer face of a circular cylinder commensurate with the dimensions of said seat face whereby said stopper body is rotatable within the valve body about a common axis shared by the valve body and the valve stopper, a valve stem extending axially from the stopper body, and a fluid communication passage formed into said stopper body for providing fluid communication between said one or more inlet ports penetrating said housing wall and a selected one or more of said outlet ports; and drive means operatively interposed between said valve stem and said valve housing for generating relative rotating motion of said valve stopper with respect to said valve body.

This invention relates to a motorized valve. The invention has particular application to a motorized valve for spa baths or spa pools. However, the motorized valve according to the present invention may have application in other areas requiring sequential diversion of fluid, particularly liquid, flow from a pump or pressure source.

The term spa pool and spa bath are often used interchangeably in the art. However, in case there is any difference in meaning of the two terms, it is to be understood that in this specification, the term spa pool will be used to refer to both spa baths and spa pools. Most spa pools include a plurality of hydrotherapy jets permanently affixed to, or penetrating, the shell or vessel of the spa pool. For example, there may be four “seats” within a spa pool, each seat being disposed in juxtaposition with several fixed-position jets strategically located to massage key muscle groups in a human user's back. When in use, the fixed nature of the hydrotherapy jets can create a condition wherein the constant, fixed jet pressure can create an uncomfortable feeling for the user.

While there exist hydrotherapy jets which can provide limited movement within their respective jet bodies, the movement is constrained by the size and shape of the specific hydrotherapy jet and is not always effective at eliminating the uncomfortable condition created.

A diverter valve has been provided which attempts to sequential selection of hydrotherapy jets in a spa pool. The diverter valve is disclosed in U.S. Pat. No. 6,112,341 in the name of Gerald W. Moreland, assigned to ITT Manufacturing Enterprises Inc., hereinafter referred to as the Moreland valve. However, there are significant deficiencies in the Moreland valve which have limited the acceptance of the valve in the market. Firstly, the existing valve uses a “water motor” to drive an internal diverting component from the water flow delivered by the spa pool pump. While this method of driving the internal diverting component is energy efficient, it does not provide for a constant, repeatable rotational speed of the internal diverting component. Therefore, different horsepower pumps and/or different spa pool plumbing systems will result in different speeds of rotation of the internal diverting component based on the resultant differing flow of the driving pump. This creates an inconsistent, ineffective, and undesirable diverting action.

Secondly, the Moreland valve reduces the effective pressure delivered to each hydrotherapy jet as the valve rotates through a complete cycle because the valve internal diverting component, often diverts water to multiple pairs of outlet ports at the same time, thereby reducing the effective pressure delivered to any specific pair of outlet ports. The Moreland valve requires water to pass through a diffuser disk to reduce the force on a selector disk, with the result that the valve is mechanically and hydrodynamically inefficient, requiring a larger motor to deliver the required flow and pressure to the jet nozzles. The arrangement has a reduced hydrotherapy effect on the user.

The internal diverting component of the Moreland valve is called a Geneva valve. Such a term is not common to the field of valves, but is akin to a similar arrangement in horological devices where a smooth rotary motion is converted into an intermittent rotary motion. The terminology “internal diverting component” as used in describing the Moreland valve functions as what is often called a “valve stopper”, and this terminology will be used to hereinafter when describing the motorized valve of the present invention.

Another diverter valve is disclosed in U.S. Pat. No. 5,548,854 in the name of John M. Bloemer et al, assigned to Kohler Co., hereinafter referred to as the Kohler valve. The valve stopper of the Kohler valve has a tendency to bind against the valve body. Because there is only one opening an uneven pressure is exerted on the disk portion of the valve stopper. This uneven pressure combines with the amount of force exerted on the disk with the result that the motor may become overloaded when the disk binds against the housing.

The present invention aims to provide a motorized valve which ameliorates one or more of the problems of the prior art. The present invention also aims to provide a motorized valve which is more efficient in mechanical operation and/or in terms of fluid pressure loss. The present invention also aims to provide a motorized valve which reduces the pump motor power requirements and/or saves energy. Other advantages of the invention may become apparent from the following description.

With the foregoing in view, in one aspect the present invention resides broadly in a motorized valve including:

a valve body having a housing wall and one or more inlet ports and a plurality of outlet ports penetrating the housing wall;

each outlet port being arranged in spaced relationship from one another about a seat face, said seat face substantially conforming to an inner face of circular cylinder and each said outlet port having an orifice penetrating said seat face;

a valve stopper having
a stopper body formed with a sealing face conforming to an outer face of a circular cylinder commensurate with the dimensions of said seat face whereby said stopper body is rotatable within the valve body about a common axis shared by the valve body and the valve stopper,
a valve stem extending axially from the stopper body, and
a fluid communication passage formed into said stopper body for providing fluid communication between said one or more inlet ports penetrating said housing wall and a selected one or more of said outlet ports; and

drive means operatively interposed between said valve stem and said valve housing for generating relative rotating motion of said valve stopper with respect to said valve body.

In another aspect, the present invention resides broadly in a motorized valve including:

a valve body having a housing wall and one or more inlet ports and a plurality of outlet ports penetrating the housing wall;

each outlet port being arranged in spaced relationship from one another about a seat face, said seat face substantially conforming to an inner face of circular cylinder and each said outlet port having
an outlet passage orifice penetrating said seat face;
a radially directed passage extending from said orifice; and
an outlet passage extending from said radially directed passage to exit from said valve body;

a valve stopper having
a stopper body formed with a sealing face conforming to an outer face of a circular cylinder commensurate with the dimensions of said seat face whereby said stopper body is rotatable within the valve body about a common axis shared by the valve body and the valve stopper,
a valve stem extending axially from the stopper body, and
a fluid communication passage formed into said stopper body for providing fluid communication between said one or more inlet ports penetrating said housing wall and a selected one or more of said outlet passage orifices; and

drive means operatively interposed between said valve stem and said valve housing for generating relative rotating motion of said valve stopper with respect to said valve body.

Preferably, the drive means is selected from either drive means having fixed rotational drive speed or drive means having controllable drive speed. It will be seen that in the case of the fixed speed drive means, fluid may be diverted sequentially through a plurality of ports which, in the particular application of the present invention, lead to fixed hydrotherapy jets in such a manner as to eliminate the uncomfortable pressure delivered by fixed, constant flow jets of the prior art while providing for a true massaging action.

Preferably, the fluid communications passage through the valve stopper includes a plurality of the stopper ports arranged in regularly spaced disposition circumferentially about the outer sealing face for alignment in register with the corresponding number of outlet ports. Preferably, the stopper ports are arranged in diametrically opposed disposition such that the inlet port may be selectively connected to diametrically opposed pairs of outlet ports in the valve housing. However, it will be appreciated that the stopper ports may be arranged as a triplet, each 120° apart, four-fold at 90° from each other, and so forth. The arrangement is such form substantially evenly distributes the reactive force of fluid pressure on the valve body circumferentially and minimizes the reactive force axially, with a view to minimizing the torque required to drive the valve body rotationally about its axis.

In the preferred form, the motorized valve according to the invention allows for plumbing, say for example, eight hydrotherapy jets affixed to the spa pool shell in four pairs of jets, and diverting the flow of water to each row of jets in a sequential manner. Sixteen jets could also be utilized by teeing off of each outlet port of the valve and creating eight rows of two jets, or four rows of four jets. Alternatively, the stopper ports may be formed to align with a plurality of diametrically opposed pairs of outlet ports in the valve housing in axially spaced disposition about the valve housing.

In another form, the stopper ports may be formed spirally about the circumference of the cylindrical outer face of the valve body, and the outlet ports may also be arranged spirally about the valve housing. In such form, the rotation of the valve body brings the stopper ports into alignment with successive pairs, triplets or such like, to provide the mode of operation sought as one of the aims of the present invention as described herein.

The diversion of water allows for a pulse of hydrotherapy jet pressure to be delivered to specific points on the human body through a jet pair, and then sequentially moving to different points on the body through sequential jet pairs. This diversion through fixed hydrotherapy jets provides time between pulses on any given point on the human body, and alleviates the uncomfortable feeling from a constant pressure jet.

The motorized valve according to the invention may be used for a spa pool or spa bath as a sequential jet diverter valve which provides for sequentially diverting water flow to a pair of jets in a “bank” of jets located in a specific location or seat of a spa pool or bath. In one form, a single influent port is provided in direct hydraulic communication with a pump, a valve stopper is connected for movement to a motor to drive the valve stopper into register with selected ones of eight outlet ports in direct hydraulic communication with at least four pairs of hydrotherapy jets. The spacing of the successive outlet ports with the stopper ports may be irregular to accommodate different pulsing on selected parts of the body.

In order that the invention may be more readily understood and put into practical effect, reference will now be made to the following drawings which illustrate a preferred embodiment of the invention, and in which:

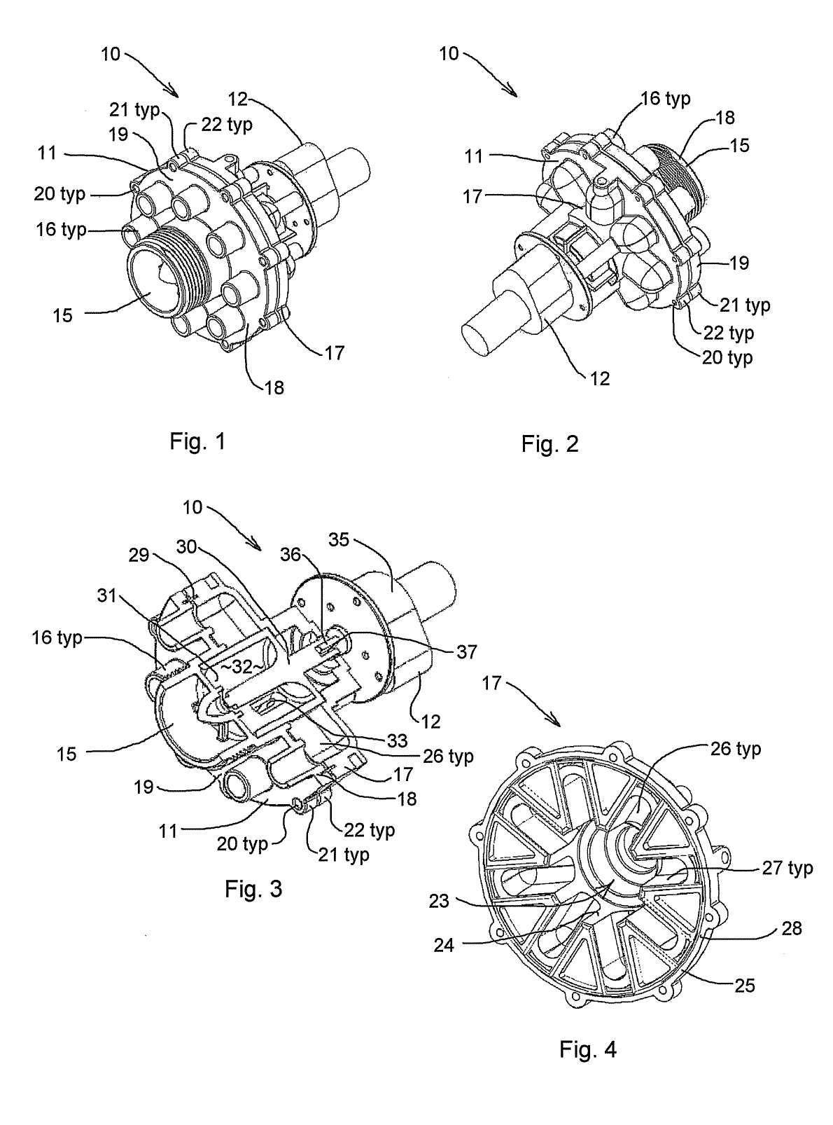

FIG. 1 is a pictorial view of a motorized valve according to the invention;

FIG. 2 is a pictorial view of the motorized valve of FIG. 1 from the other end and other side;

FIG. 3 is a pictorial, partly cut away view of the motorized valve of FIGS. 1 and 2;

FIG. 4 is a pictorial view showing the internal detail of a manifold part for the motorized valve of FIG. 1;

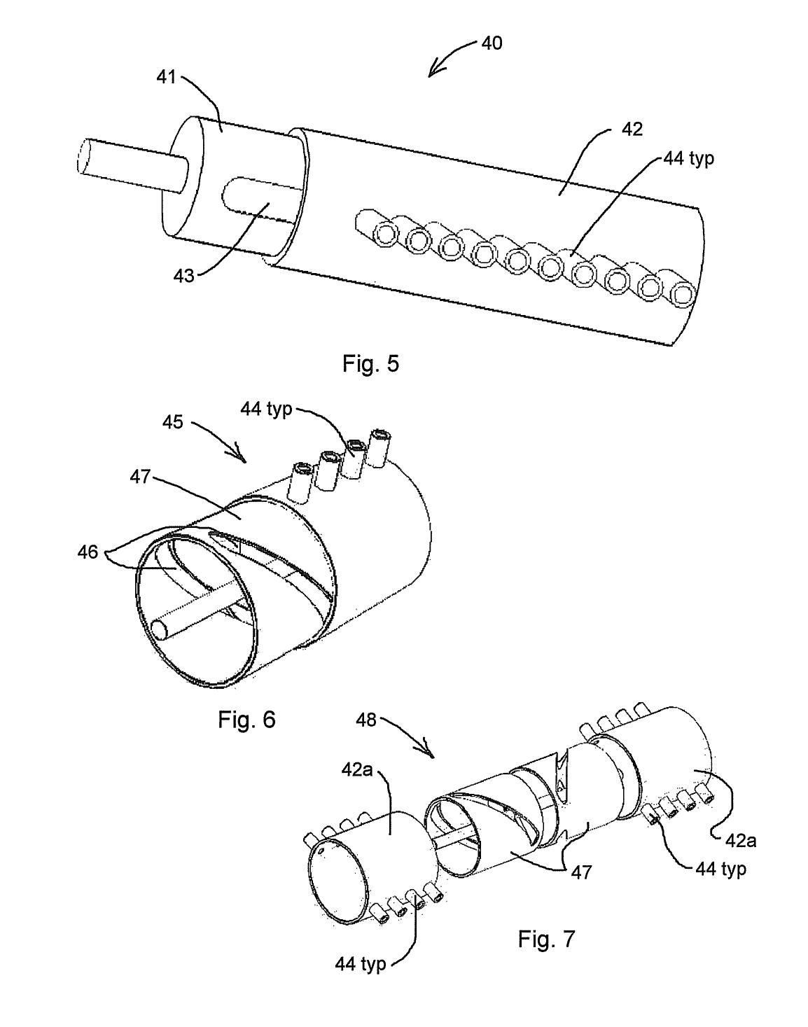

FIG. 5 is a pictorial, partly exploded view showing the internal detail of an alternative form of valve stopper and valve body for a motorized valve according to the invention; and

FIGS. 6 and 7 are a pictorial views showing another alternative form of valve stopper for the valve body shown in FIG. 5.

The motorized valve 10 illustrated in FIGS. 1 to 3 includes a valve body 11 and a drive 12. The valve body is predominantly circular in cross section and has a common axis with the drive. The valve body includes an inlet port 15 which is circular in cross section and coaxial with the common axis of the valve body and the drive. The inlet port is in the form of a tubular stub projecting axially from the remainder of the valve body and has a pipe thread running about its external circumference.

Eight outlet ports shown typically at 16 are arranged radially outward from the inlet port, only three whole and two halves of which are shown in FIG. 3. Each outlet port is in the form of a tubular stub projecting coaxially from the remainder of the tube body in the same direction as and substantially parallel to the tubular stub of the inlet port.

The valve body is made up of two principle parts, referred to for convenience as a manifold part 17 and a cap 18. The cap includes the tubular stubs for the inlet and outlet ports, the outlet ports projecting from a cap flange 19 extending radially from the inlet port. The cap is sealingly connected to the manifold part by eight fasteners shown typically at 20 which are inserted into fastener apertures penetrating through eight corresponding scalloped projections shown typically at 21 about the outer periphery of the cap flange. The scalloped projections are arranged to be in register with corresponding formations shown typically at 22 about the periphery of the manifold part.

The manifold part of the valve body is illustrated to show its internal detail in FIG. 4, wherein it will be seen that a valve chamber 23 is surrounded by a surrounding wall 24 from which a manifold flange 25 extends radially. Eight radial passages shown typically at 26 pass from the valve chamber and through the manifold flange by the provision of a radial passage wall shown typically at 27 for each radial passage. The manifold flange has a sealing face 28 which provides a seal against the cap with the co-operation of a seal 29 interposed between the cap and the manifold part. The radial passage walls protrude from the face of the manifold flange remote from the sealing face. An inner orifice provides fluid communication between each radial passage and the valve chamber, each adjacent inner orifice being separated from the other by a portion of the surrounding wall.

Each radial passage is in register with a corresponding outlet port which also penetrates through the cap flange. A valve stopper 30 is provided within the valve chamber and has an external valve wall 31 sized to seal against the inner face of the surrounding wall of the valve chamber. The valve stopper has a flow passage 32 having a valve orifice in fluid communication with the inlet port and two diametrically opposed selector openings 33 penetrating the external valve wall, only one of which is shown in FIG. 3. The selector opening is smaller, particularly in the circumferential direction, than the inner orifice of the flow passages so that alignment of the valve stopper by rotation thereof within the valve chamber provides fluid communication from the inlet port to a selected opposed pair of the outlet ports for a longer time than between two circumferentially adjacent pairs of the outlet ports as the valve stopper rotates.

The valve stopper is rotatable by a motor 35 having a keyed shaft 36 which extends into a corresponding drive aperture 37. The drive aperture is similarly keyed to provide for rotation of the valve stopper with the rotation of the keyed shaft.

The alternative form of valve body and valve body 40 illustrated in FIG. 5 includes an alternative valve stopper 41 mounted for rotation within an alternative valve housing 42, but being shown partially withdrawn from its operative position within the alternative valve housing. The valve stopper includes two diametrically opposed stopper ports 43, one of which is visible in FIG. 5. The valve housing includes ten diametrically opposed pairs of housing ports in axially directed, slot-like form shown typically at 44, again, one of each pair being visible in FIG. 5.

The other alternative valve body 45 illustrated in FIGS. 6 and 7 includes two alternative stopper ports 46, each being arranged spirally about the outer cylindrical face 47 of the valve body, each part of each alternative stopper port being substantially diametrically opposed to the other. There are only four pairs of housing ports in each case, but it will be seen that in the form illustrated in FIG. 7 in particular, more than one valve stopper and housing may be provided in a set along a common shaft, permitting expansion of the capacity of the motorized valve according to the invention, the number of sets being limited by the torsion limit of the drive shaft and/or the power of the motor driving the valve.

The motorized valve according to the present invention utilizes an electric motor to drive the internal part at a constant, desired angular velocity in order to eliminate one of the shortcomings of valves according to the prior art. In a preferred embodiment, a 12-volt gear motor is used to deliver six rpm constantly on the valve stopper inside the valve chamber, the, valve stopper performing the function of an internal diverting component. It is expected that this arrangement is suited for a range of size of the main pump or the plumbing system used on any given spa pool. The constant angular velocity of the motor could be changed to provide a different cycle time according to the spa pool manufacturer's specifications.

In another embodiment of the present invention, an electronically controlled motor may be utilized to provide variable speed control of the valve stopper, allowing the user to set the diverting action to the user's desires.

In yet another embodiment of the present invention, a stepper motor may be utilized to provide for a specified “dwell” and “run” time, and at a selected angular velocity of the internal component. Dwell time would represent the amount of time the motor and valve stopper dwells or pauses at each pair of jets before moving to the next pair. The run time/rpm represents the time between pairs of jets. This embodiment would allow the user to specify a desired full pressure time at each pair of jets, and the time between pairs of jets.

To eliminate another shortcoming of valves according to the prior art, the motorized valve according to the present invention utilizes spatial relationships between the valve stopper and the outlet lateral bore, and the outlet ports. In the embodiment illustrated in the drawings, the width of the effective flow area of the outlet bore is a minimum of 75% wider than the width of the effective flow area of the valve stopper. Further, the effective flow area of the valve stopper is 30% larger than the outlet ports. These relationships allow for the valve stopper to deliver full flow and pressure to a pair of ports on a minimum of a 2:1 ratio. In other words, as the internal component rotates within the valve body, it will deliver full flow to a pair of jets for twice the amount of time that it is delivering flow to more than a pair of jets ensuring that the full hydrotherapy effect is delivered at least 66% of the time.

It will be seen that the motorized valve according to the present invention provides a motor-driven diverter valve for use on spa pools and spa baths that diverts water flow from the pump to a plurality of hydrotherapy jets in a specific location or seat, and delivers said water flow and pressure to at least two hydrotherapy jets at a time in a sequential manner. The valve in one form utilizes a fixed and constant rpm motor to rotate the valve stopper in the valve chamber. The valve in another form utilizes an electronically controlled, variable speed motor. The valve in yet another form utilizes a stepper motor, which has programmable dwell and run times.

The valve has at least one influent port in direct fluid communication with a pump. The valve has at least two outlet ports in direct fluid communication with at least two hydrotherapy jets. The valve delivers maximum water flow to at least two hydrotherapy jets for at least the same amount of time that the valve is delivering less than maximum water flow to at least two hydrotherapy jets.

Although the invention has been described with reference to a specific example, it will be appreciated by persons skilled in the art that the invention may be embodied in other forms within the broad scope and ambit of the invention as herein set forth and defined by the following claims.

1. A motorized valve including:
a valve body having a housing wall and one or more inlet ports and a plurality of outlet ports penetrating the housing wall;
each outlet port being arranged in spaced relationship from one another about a seat face, said seat face substantially conforming to an inner face of circular cylinder and each said outlet port having an orifice penetrating said seat face;
a valve stopper having
a stopper body formed with a sealing face conforming to an outer face of a circular cylinder commensurate with the dimensions of said seat face whereby said stopper body is rotatable within the valve body about a common axis shared by the valve body and the valve stopper,
a valve stem extending axially from the stopper body, and
a fluid communication passage formed into said stopper body for providing fluid communication between said one or more inlet ports penetrating said housing wall and a selected one or more of said outlet ports; and
drive means operatively interposed between said valve stem and said valve housing for generating relative rotating motion of said valve stopper with respect to said valve body.

2. The motorized valve according to claim 1, wherein the drive means has fixed rotational drive speed.

3. The motorized valve according to claim 1, wherein the drive means has controllable drive speed.

4. The motorized valve according to claim 1, wherein the fluid communications passage through the valve stopper includes a plurality of the stopper ports arranged in regularly spaced disposition circumferentially about the outer sealing face for alignment in register with the corresponding number of outlet ports.

5. The motorized valve according to claim 4, wherein the stopper ports are arranged in diametrically opposed disposition such that the inlet port may be selectively connected to diametrically opposed pairs of outlet ports in the valve housing.

6. The motorized valve according to claim 1, wherein the stopper ports are formed spirally about the circumference of the cylindrical outer face of the valve body.

7. The motorized valve according to claim 1 or claim 6, wherein the outlet ports are arranged spirally about the valve housing.

8. The motorized valve according claim 1 as a sequential jet diverter valve which provides for sequentially diverting water flow to a pair of jets in a “bank” of jets located in a specific location or seat of a spa pool or bath. In one form, a single influent port is provided in direct hydraulic communication with a pump, a valve stopper is connected for movement to a motor to drive the valve stopper into register with selected ones of eight outlet ports in direct hydraulic communication with at least four pairs of hydrotherapy jets.

9. A motorized valve including:
a valve body having a housing wall and one or more inlet ports and a plurality of outlet ports penetrating the housing wall;
each outlet port being arranged in spaced relationship from one another about a seat face, said seat face substantially conforming to an inner face of circular cylinder and each said outlet port having
an outlet passage orifice penetrating said seat face;
a radially directed passage extending from said orifice; and
an outlet passage extending from said radially directed passage to exit from said valve body;
a valve stopper having
a stopper body formed with a sealing face conforming to an outer face of a circular cylinder commensurate with the dimensions of said seat face whereby said stopper body is rotatable within the valve body about a common axis shared by the valve body and the valve stopper,
a valve stem extending axially from the stopper body, and
a fluid communication passage formed into said stopper body for providing fluid communication between said one or more inlet ports penetrating said housing wall and a selected one or more of said outlet passage orifices; and
drive means operatively interposed between said valve stem and said valve housing for generating relative rotating motion of said valve stopper with respect to said valve body.

10. The motorized valve according to claim 9, wherein the drive means has fixed rotational drive speed.

11. The motorized valve according to claim 9, wherein the drive means has controllable drive speed.

12. The motorized valve according to claim 9, wherein the fluid communications passage through the valve stopper includes a plurality of the stopper ports arranged in regularly spaced disposition circumferentially about the outer sealing face for alignment in register with the corresponding number of outlet ports.

13. The motorized valve according to claim 12, wherein the stopper ports are arranged in diametrically opposed disposition such that the inlet port may be selectively connected to diametrically opposed pairs of outlet ports in the valve housing.

14. The motorized valve according to claim 9, wherein the stopper ports are formed spirally about the circumference of the cylindrical outer face of the valve body.

15. The motorized valve according to claim 9 or claim 14, wherein the outlet ports are arranged spirally about the valve housing.

16. The motorized valve according claim 9 as a sequential jet diverter valve which provides for sequentially diverting water flow to a pair of jets in a “bank” of jets located in a specific location or seat of a spa pool or bath. In one form, a single influent port is provided in direct hydraulic communication with a pump, a valve stopper is connected for movement to a motor to drive the valve stopper into register with selected ones of eight outlet ports in direct hydraulic communication with at least four pairs of hydrotherapy jets.
